(19) United States
(12) Patent Application Publication
(10) Pub. No.: US 2006/0025885 A1
(43) Pub. Date: Feb. 2, 2006

(54) APPARATUS AND METHOD FOR LOADING DATA STORAGE DEVICES INTO CARRIERS

(75) Inventors: Thomas Michael Steffl, Frankfort, IL (US); Keith Andrew Talbot, Lombard, IL (US)

Correspondence Address: BLACKWELL SANDERS PEPER MARTIN LLP, 720 OLIVE STREET, SUITE 2400, ST. LOUIS, MO, 63101, US

(73) Assignee: THE FORM HOUSE, INC., Bedford Park, IL (US)

(21) Appl. No.: 10/710,777

(22) Filed: Aug. 2, 2004

(51) Int. Cl. G06F 7/00

(52) U.S. Cl. 700/217

(57) ABSTRACT

An apparatus and method are provided that are operable to install data storage devices such as CDs and DVDs each into a respective carrier. The data storage devices are placed in respective recesses in the respective carriers by providing an open pocket into which the data storage devices may move under the influence of gravity when the data storage device is close to the recess within a respective carrier. A securement device is provided to secure the data storage device within a respective carrier recess.

### BACKGROUND OF INVENTION

Data storage devices such as CDs and DVDs are commonly shipped, sold and displayed in carriers such as trays, often called jewel cases. The carriers typically are formed of a polymeric or plastic material and have a recess for receipt and storage therein of the data storage device. The data storage device has a central through hole. A post with retaining ears or a retaining rib is inserted through the through hole to releasably retain the data storage device within the carrier recess. Other forms of securement may be available. The data storage devices are prone to scratching when they engage other objects and in particular when being handled by machines or rub against metal or other abrasive material. Additionally, when installing a data storage device in a carrier, precise positioning of the data storage device relative to the carrier is required in order to align the through hole with the post and to avoid excessive relative movement between the storage device and the carrier to prevent scratching. Oftentimes, the placement of a data storage device in a carrier is done by hand, which is both slow and expensive.

There is a trend towards the sale of data storage devices in “multiple data storage device packages.” These are oftentimes used for a multiple DVD set of movies or a multiple CD set of a particular artist's work. Multiple data storage device sets are often sold in foldable “books” where the spacing between the particular carriers may be different. An apparatus for manufacturing devices for storing and displaying, multiple DVD or CD sets is disclosed in application Ser. No. 10/709,617, filed May 18, 2004, and entitled APPARATUS AND METHOD FOR PREPARING A DVD CARRIER ASSEMBLY, the disclosure of which is incorporated herein by reference.

While many carriers or trays have a single recess for a single data storage device, there is a trend towards having carriers or trays with multiple recesses for storing a plurality of data storage devices with one data storage device overlying a portion of another data storage device when in position in the carrier. The use of multiple recess carriers complicates the filling process and the apparatus for inserting the data storage devices each into their respective recess.

Thus, there is a need for an improved method and apparatus for installing data storage devices in carriers.

### SUMMARY OF INVENTION

The present invention involves the provision of both an apparatus and method for installing data storage devices in carriers. The data storage devices include digital media devices such as CDs and DVDs. The apparatus includes a conveyor system for moving carriers from an in-feed portion toward a discharge portion with the recesses in the carriers being exposed. The carriers are conveyed at an angle relative to horizontal such that the carriers are inclined. A member overlies a portion of the carriers and the recesses during conveying, forming a pocket with an opening at a lower portion of the carrier. A portion of the side wall defining the recess in the carrier forms a guide channel for guiding movement of the data storage device into the pocket and hence the recess. The recess sidewall also orients the through hole in the data storage device to a post in the carrier, which post is inserted through the hole to secure the data storage device within the carrier recess. Gravity may be used to induce movement of the data storage device into the pocket and recess. The data storage device may be moved into position for placement into a respective recess in either a leading, trailing, or a centered position relative to the recess while the carrier is moving allowing a continuous movement or incremental or sequential movement conveyor system, as desired. A securement device engages the data storage device and urges the post to move through the data storage device through hole.

The present invention provides a method for installing data storage devices in a respective carrier wherein carriers are moved through a filling station wherein data storage devices are positioned adjacent a carrier in the filling station. A pocket is provided for allowing the data storage device to move therein at least partially under the influence of gravity utilizing portions of the carrier as guides for movement of the data storage devices into the carrier recess is used orient the data storage device relative to a mounting post. After installation of the data storage device into the recess, the data storage device is pressed over a portion of the mounting post for securement of the data storage device within the recess.

### BRIEF DESCRIPTION OF DRAWINGS

FIG. 1 is a perspective view as viewed from a discharge end portion of the apparatus with a portion of one belt not being shown to illustrate details of the apparatus.

FIG. 2 is a fragmentary perspective view of the apparatus of FIG. 1 but viewed from a feed end portion also with one of the belts not shown to illustrate details of the apparatus.

FIG. 3 is an end view of the filling station portion of the apparatus looking from the discharge end portion toward the feed end portion.

FIG. 4 is a top plan view of the apparatus of FIG. 1.

FIG. 5 is an enlarged fragmentary view at the filling station showing a data storage device in a position prior to moving into a carrier recess.

FIG. 6 is view similar to FIG. 5 but showing the carrier sectioned and a data storage device within the carrier recess but not yet mounted to the carrier post.

FIG. 7 is view similar to FIG. 6 but with the carrier and data storage device at the pressing station showing the data storage device mounted to the post.

FIG. 8 is a plan view of a modified form of the present invention showing multiple filling stations adapted for installing data storage devices into carriers having a plurality of recesses.

FIG. 9 is a perspective view of a carrier with a single recess.

FIG. 10 is a perspective view of a carrier having multiple recesses and mounting posts.

FIG. 11 is an enlarged fragmentary perspective view of a modified form of magazine for storing and dispensing data storage devices.

FIG. 12 is a fragmentary end view of the modified form of magazine shown in FIG. 11 along with certain details of the cam drive system for attachment devices.

FIG. 13 is an enlarged fragmentary top plan view of a modified version of an attachment device adapted for removing data storage devices from a respective magazine.

FIG. 14 is a plan view of a second modified form of invention similar to the form shown in FIG. 8 but with an additional filling station.

Throughout the drawings, like numbers are used to designate either like or similar parts as more fully described in the detailed description.

### DETAILED DESCRIPTION

The reference number 1 designates generally, an apparatus for inserting data storage devices 3 each into a respective carrier 5 such as a tray and to effect releasable securement therein. The apparatus 1 includes a conveyor system 7, a filling or loading station 9 and securement station 11. The conveyor system 7 includes an in-feed or feed end portion 13 and a discharge end portion 15. A take-away conveyor 17 may be positioned adjacent the discharge end portion 15 and an in-feed conveyor (not shown) may be positioned adjacent to the feed end portion 13 for feeding carriers 5 to the conveyor system 7.

The data storage device 3 is preferably generally round and is generally planar. The data storage device 3 has a through hole 19 between the surfaces 14, 16 for a purpose later described. Data storage devices 3 are preferably for digital media and may be CDs, Mini CDs, DVDs, or the like. Such data storage devices are well known in the art. The storage devices 3 also have a peripheral edge 20 that may be round around the entire periphery or may be rounded around a portion of the periphery.

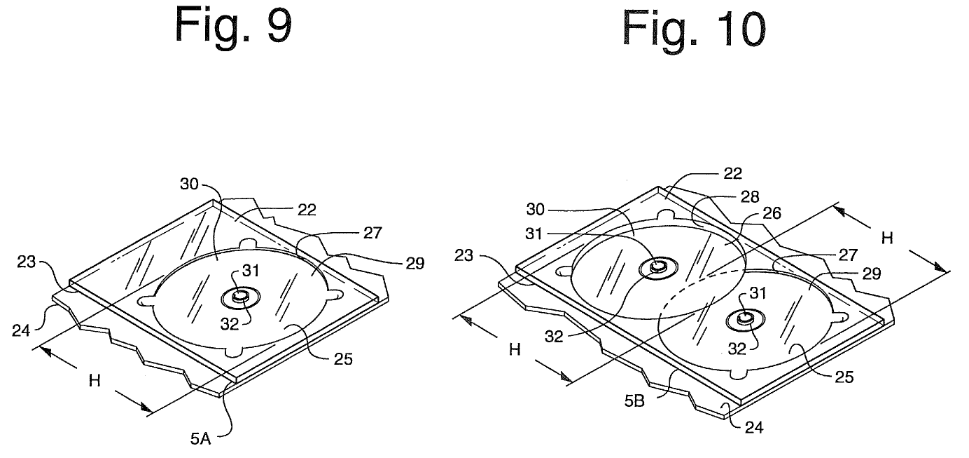

The carrier 5, as seen in two embodiments in FIGS. 9 and 10, are in the form of a tray having opposite faces 22, 23. The faces 22, 23 are generally parallel. The face 23 may be secured to a carrier strip 24 as described in the above-referenced co-pending patent application. Two different carriers 5 are designated 5A and 5B for convenience. The difference between the two forms of carriers 5A, 5B is that the carrier 5A has a single recess 25 while the carrier 5B has a plurality of recesses 25, 26. The recesses 25, 26 have a depth preferably greater than the thickness of a storage device 3 to keep its exposed surface 14 below flush with the face 23. The recesses 25, 26 are each defined by a respective side wall 27, 28 and a respective bottom wall 29, 30. A securement device 31 such as a central post is provided to releasably retain a storage device 3 within a respective recess 25, 26. The securement device 31 may be provided with a lock device 32 such as a peripheral rib or outwardly projecting ears that overlie a portion of the storage device 3 to releasably retain same within the respective recess 25, 26. Carriers 5 are well known in the art and need not be further described herein. The lock device 32 of the securement device 31 provides for a snap lock type of securement that is both easy to effect for securement and easy to effect release of the data storage devices 3 from securement.

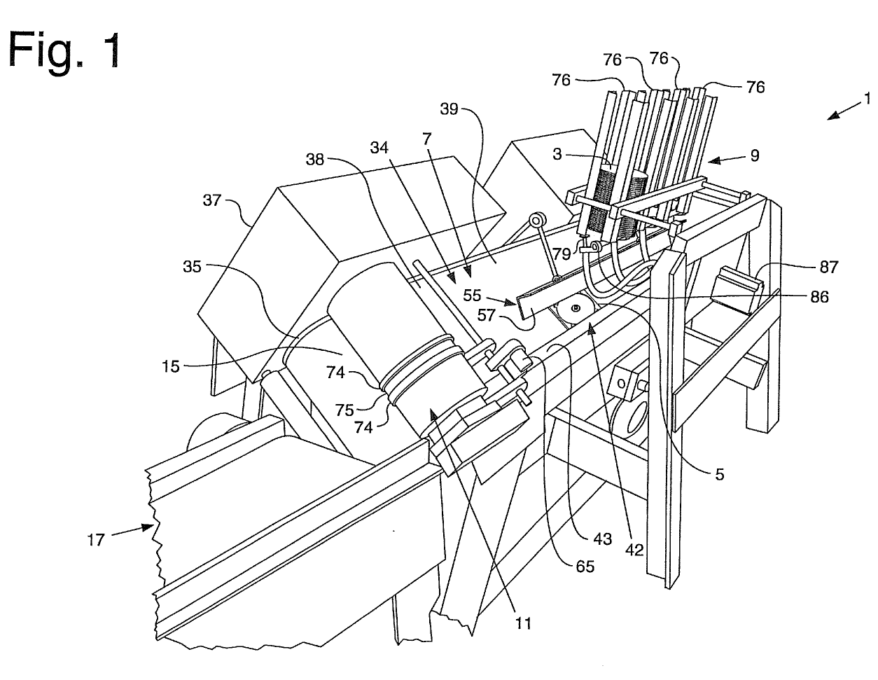

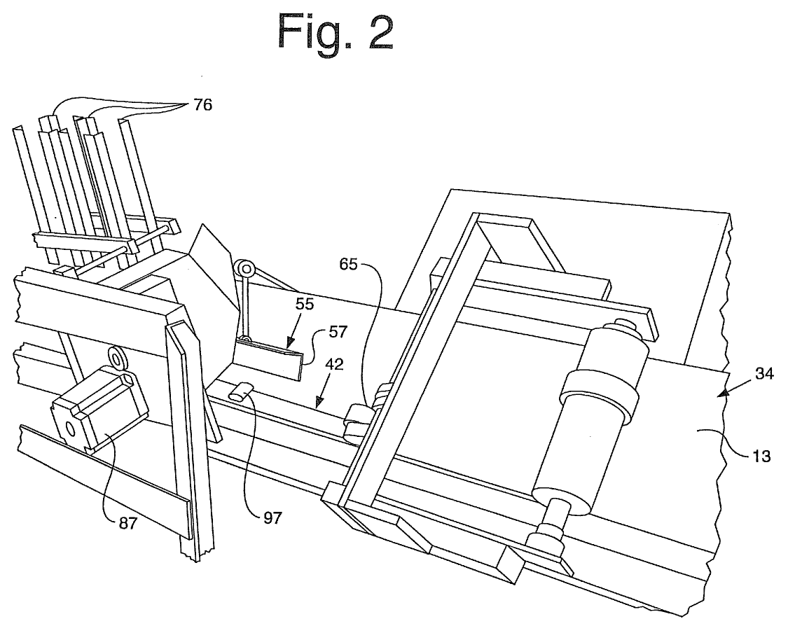

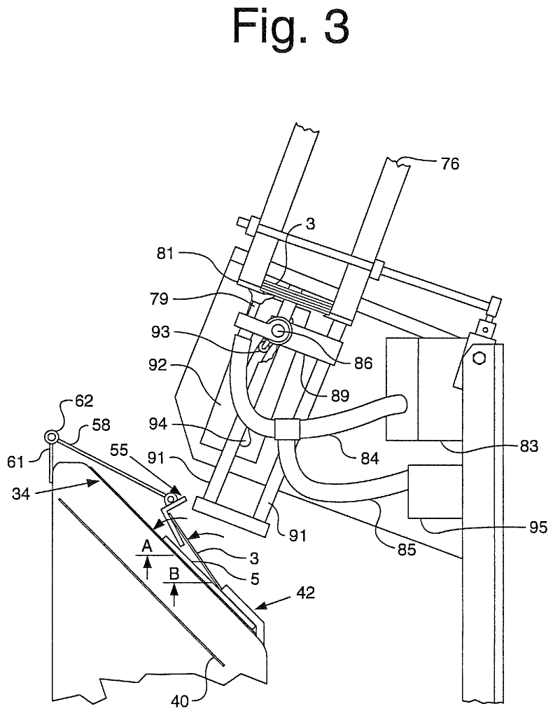

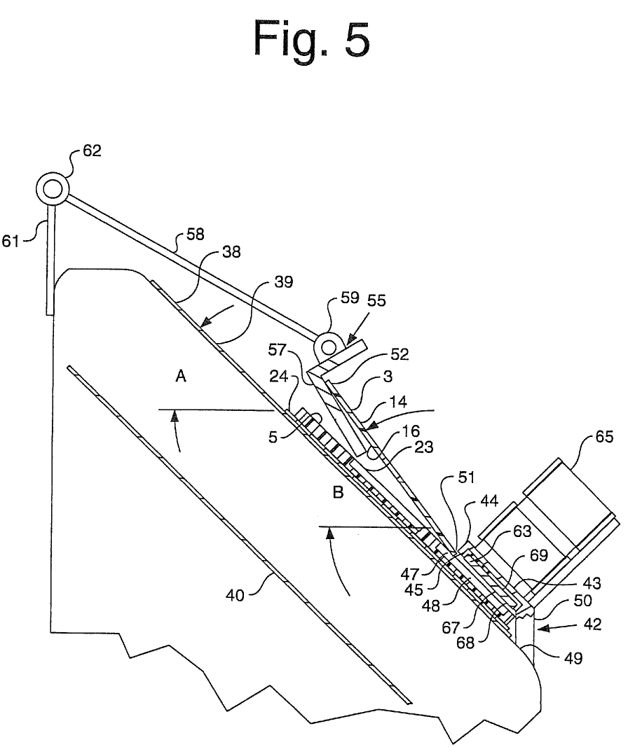

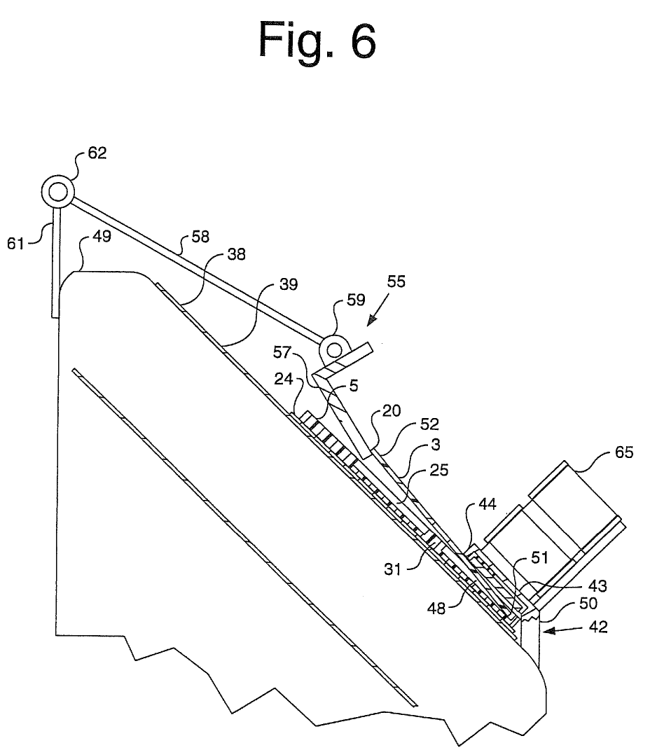

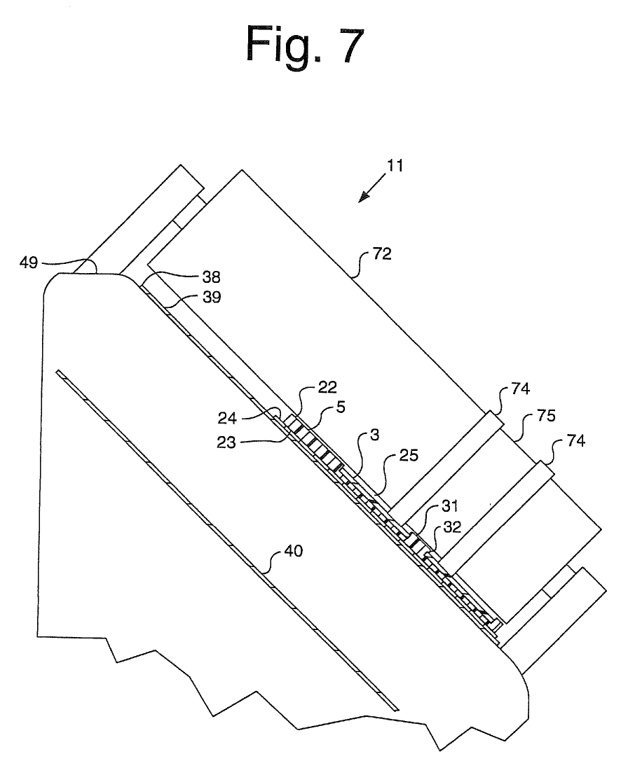

The apparatus 1 includes the conveyor system 7 which is best seen in FIGS. 1, 2. The conveyor system 7 includes a first conveyor designated generally 34 which rides over end rollers 35 with one end roller being shown in FIG. 1. The conveyor 34 is power driven as for example, with a power drive 37. The conveyor 34 has an upper run 38 with an exposed face 39 and a lower run 40 (FIG. 7). The exposed face 39 is generally planar and lies at angle A from horizontal, FIG. 3, of at least about 25°, preferably at least about 35°, and more preferably in the range of between about 35° and about 60°. Good results have been achieved by using an angle A of 45° at the filling station 9. The exposed face 39 transports the carriers 5 in a direction from the feed end portion 13 toward the discharge end portion 15. As best seen in FIGS. 1, 5, 6, the conveyor system 7 includes a guide structure designated generally 42. The guide structure 42, as illustrated, includes an elongate guide member 43 that extends along a portion of the conveyor 34 and beyond opposite ends of the filling station 9. As best seen in FIG. 5, the guide structure 42 is positioned above and spaced from the exposed face 39. The guide 43 includes a shoulder 44. The face 23 of the carrier 5 is spaced from an inside surface 45 of the member 43 and is sufficiently close to preclude a storage device 3 from entering a guide slot 47 formed between the guide structure 42 and the face 39 of the upper run 38. A generally upwardly opening pocket 48 is formed by a recess 25 or 26 and the guide structure 42 for selective receipt therein of a data storage device 3. The guide structure 42 is mounted to a conveyor belt support 49 adjacent its lower edge, as for example by a bracket 50 or series of brackets 50. As shown, the shoulder 44 is generally perpendicular to the face 39 and surface 22. The angle of inclination of the shoulder 44 is such as to allow the storage device 3 to slide off under the influence of gravity and to overcome the friction between the shoulder and storage device should a storage device 3 engage it after release as described below. When at a release position at the filling station 9, the data storage device 3 is held at and when released is at an angle B slightly greater than the angle A for example, in the range of about 2° to about 5° greater than the angle A. Thus, the angle B is as seen in FIG. 6, when the carrier 5 has its recess 25 come close to the lower end 51 of a data storage device 3, the lower end 51 will move into the pocket 48 formed between the surface 45 and the bottom wall 29 its top edge portion 52 rests on a support flange 57 of a support structure 55 whereby the storage device 3 will move into the recess 25 with the side wall 27 guiding the storage device into position within the recess 25. The through hole 19 will be positioned in proper alignment with the securement device 31 without the need for additional guide or locator structure. Contact of the storage device 3 with the flange 57 helps the storage device enter the pocket 48 and recess 25 while reducing sliding contact with the storage device 3. It has been found in operation, that the carrier 5 may lead or even trail the position of the storage device 3 and with the storage device being at least partially round, it has its own “tapered” lead and will be guided or led into position in the respective recess 25 by moving toward either the feed end portion 13 or discharge end portion 15. The support structure 55 is mounted to the belt support 49 as best seen in FIG. 5. As seen, the support structure 55 is mounted pivotally to a pair of support rods 58 as at hinge connections 59. The use of hinge connections 59 allows adjustment of the angle of the flange 57 and hence the data storage device 3. The rods 58 are mounted to second supports 61 that are in turn secured to the belt support 49. Preferably, the rods 58 are movable relative to the support 61 as at 62 so that the position of the support structure 55 relative to a recess 25 in a carrier 5 may be effected. When a storage device 3 moves into a recess 25, it moves out of contact with the flange 57. Preferably, the shoulder 44 is positioned over the recess 25 such that about the lowermost 10%-40% of the height or effective height H of the recess 25 or 26 is covered.

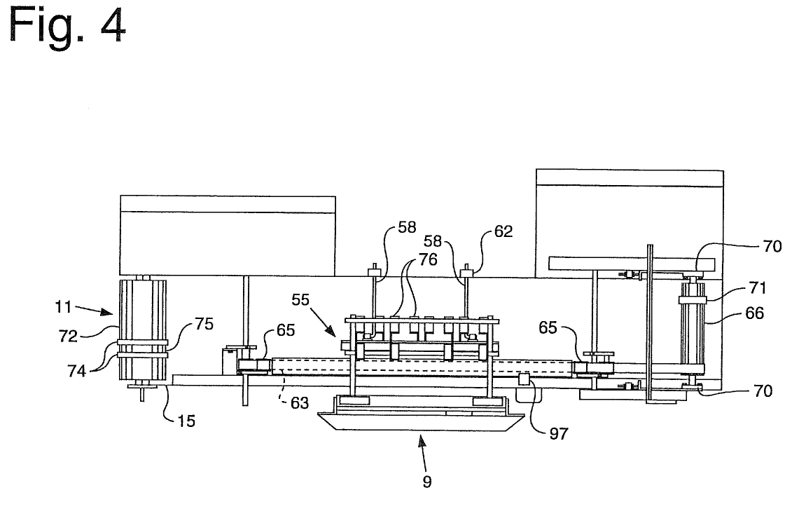

As seen in FIG. 5, the guide structure 42 includes a movable conveyor member such as a conveyor belt 63 that is preferably power driven and moves synchronously with the belt 38. The belts 38 and 63 may be driven by the same power drive 37. As seen in FIGS. 1, 4 the belt 63 engages idler roller arrangements 65 to maintain tension in the belt 63. The belt 63 has a lower run 67 with a surface 68 spaced from and generally parallel to the face 39 forming the slot 47 therebetween. With the lower run 67 moving at the same speed as the upper run 38, there is no or little relative movement between a carrier 5 or storage device 3 carried by the belt 39 and the surface 68 thereby preventing scratching of either the face 22 of the carrier or the data storage device 3. Preferably, the lower run 67 rides in a groove 69 formed in the guide 43. The groove 69 may be lined with a friction reducing material such as polytetrafluroethylene (PTFE) which would also have a guide groove therein for receipt of the lower run 67 therein. Preferably, the guide structure 42 extends beyond opposite ends of the filling station 9. Rollers 66 may be rotatably mounted above the conveyor 34 as on journals 70. A collar 71 may be provided. The rollers 66 may be power driven as with belt 63. The collars 71 may be used as a guide to prevent the carriers 5 from riding too high on the conveyor 34.

The securement station 11, as seen in FIGS. 1, 2, 4 and 8, is operable for urging a storage device 3 into retainment by the lock device 32 of the securement device 31 of the carrier 5. In the illustrated structure, the securement station 11 includes a roller 72 which may be power driven or of idler-type and is positioned across the width of conveyor 34 adjacent the discharge end portion 15. As seen in FIGS. 1 and 4, the roller 72 includes a pair of collars 74 projecting from an exterior surface of the roller 72 and having a gap 75 therebetween with the gap having a width approximately equal to or slightly larger than the transverse dimension of the securement device 31. As a storage device 3 and its respective carrier 5 move under the roller 72, during conveying by the conveyor 34, the securement device 31 is aligned with the groove 75 and when the collars 74 engage the exposed surface 14 of the storage device 3, the collars will force the through hole 19 over the securement device 31 and past the lock device 32, both being aligned during the filling operation at the filling station 9, to releasably secure the storage device 3 within the recess 25 of a carrier 5. Preferably, the collars 74 are made of a relatively soft and resilient non-marring elastomeric or polymeric foam material. The hardness of the collars 74 will be determined by the amount of force required to force the storage device 3 over the securement device 31 and past the lock device 32.

The filling station 9 is best seen in FIGS. 1, 2, 3 and 4. Any suitable device may be used at the filling station 9 for removing storage devices 3 from respective magazines 76. A suitable device for the filling station 9 is referred to as a pick and place device. Any suitable number of magazines 76 can be provided and are preferably movable along the length of the apparatus 1 to adjust for the positions of the carriers 5 relative to one another passing through the filling station 9. This is particularly important when the carriers 5 are attached to a carrier strip 24 and may not be evenly spaced and may vary from product to product. It is to be understood that the apparatus 1 may be used to load individual carriers 5 not attached to a carrier strip 24. As seen, a plurality of attachment devices 79, such as suction cups are spaced along the length of the filling station 9 with at least one being associated with each magazine 76. Each magazine 76 is adapted to hold a stack of data storage devices 3 and the storage devices are fed from the bottom of a respective magazine 76. The data storage devices 5 are held in place in a magazine 76 by resilient fingers 81 each being secured at a respective corner of a respective magazine 76. As seen, the attachment devices 79 are in the form of suction cups attached to a source of vacuum 83 via conduits 84. As seen in FIG. 3, the attachment device is preferably in a position to attach to a lower most positioned data storage device 3 in a magazine 76. The attachment devices 79 are mounted in ganged relationship on a movable support such as a support member 86 e.g., a shaft, which is driven rotationally by a power drive 87 (FIG. 2). The power drive 87 is operable to move a carriage 89 reciprocally generally up and down on guide rods 91. A cam 92 and follower 93 that follows in a cam groove 94 effects rotational movement of the support member 86 and hence the rotational position of the attachment devices 79. In the up position, which is the approximate position shown in FIG. 3, the attachment devices 79 each engage a respective data storage device 3 for releasable attachment through the application of vacuum. Downward movement of the carriage 89 applies a downward force to the respective data storage device 3 to remove it from a respective magazine 76. The attachment device 79 is offset from the center of the storage device 3 to avoid the through hole 19 and to allow the data storage device 3 to be pulled against two fingers 81 by coming out of a magazine 76 at an angle. Upon further downward movement, the data storage device 3 rotates by rotation of the member 86 and at the bottom of the stroke, is at a position where the data storage device 3 will have its lower edge 51 adjacent a respective recess 25 and pocket 48 as the carrier 5 moves by the upper edge portion 52 engage the flange 57. Preferably, the storage device 3 is in place for release prior to arrival of a respective carrier. When in the loading/release position, the vacuum from the source 83 is released allowing release of the data storage device 3 from the attachment device 79. Positive pressurized fluid such as air is preferably applied to the data storage device 3 by dispersing pressurized fluid from a source 95 to flow through a conduit 85 to a port in the attachment device 79 to effect disengagement of the data storage device from the attachment device 19. The release of vacuum and application of positive pressure air are timed to occur at a predetermined position of a respective carrier relative to the attachment device(s) 79. The carriage 89 will then move upwardly and rotate the member 86 via the follower 93 moving in the cam groove 94 to a position where each of the attachment devices 79 is adjacent to the next lower most positioned data storage device 3 for attachment thereto and removal from its magazine 76.

The placement of storage devices 3 for depositing in a respective recess 25 is timed to movement of carriers 5 through the respective filling station 9. In the event individual carriers 5 are fed, the carriers may be suitably indexed as with indexing lugs or the like (not shown) on the conveyor 34. In the event carriers 5 are secured to a carrier strip 24, the location of the carrier strip may be determined by a sensor 97 such as an electric eye and the vacuum will not be released until the carrier is in its approximate location which can be slightly leading, slightly trailing, or centered. When a storage device 3 is released it will engage and be partly guided by the flange 57. The flange 57 may have a friction reducing coating or layer, such as PTFE. Release of the vacuum, and application of positive pressure air, will allow the data storage devices 3 the ability to move into the respective pocket 48 and the respective recess 25. The data storage devices 3 will move into the respective pocket 48 and recess 25 under the influence of gravity once the pocket is located adjacent to the lower end 51 of the data storage device 3. Gravity will allow the data storage device 3 to move into the respective pocket 48 either when the data storage device 3 is in a leading position, trailing position, or centered position relative to the respective recess 25. By being at least partially round, the data storage devices 3 can roll into the recesses 25 and pockets 48 to accommodate any of the three aforementioned relative positions.

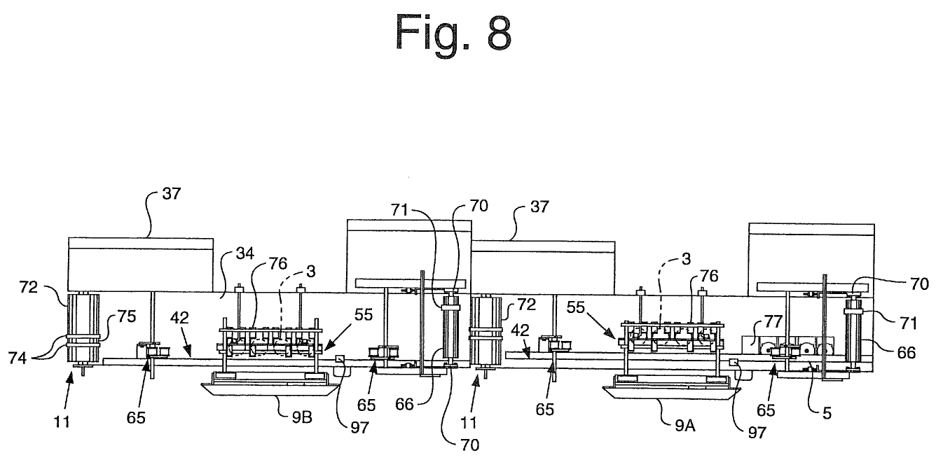

FIG. 8 shows a modified form of the present invention which differs from the first embodiment by utilizing two filling stations 9 (designated 9A, 9B in FIG. 8 for clarity) with the filling stations 9A, 9B being identical to the filling station 9 (as described above). The operation of the filling stations 9A, 9B is the same as that described above for filling station 9. The main difference between the filling stations 9A and 9B is that 9B is positioned lower on the width of the belt 34 to accommodate the lower positioned recess 25 of carrier 5B as compared to the higher positioned recess 26 (FIG. 10). Using the form of the invention shown in FIG. 8, a carrier 5B shown in FIG. 10 with two recesses 25, 26, may be filled as the first form of the invention described with regard to the single recess carrier 5A shown in FIG. 9.

The present invention is better understood by a description of the operation thereof. Carriers 5A or 5B depending upon the form of the invention used, are transported by the conveyor belt 34. The carriers 5A or 5B may be filled individually or may be secured to a carrier strip 77 such as that disclosed in co-pending application Ser. No. 10/709,617 filed May 18, 2004, the disclosure of which is incorporated herein by reference. A sensor 97 senses the position of the carrier 5A or 5B or carrier strip 24 providing information to the filling station 9A or 9B as to when to move data storage devices 3 into position and to release the vacuum and apply a positive pressure if desired, for release of the data storage devices from attachment to the attachment devices 79. The position of carriers 5A or 5B longitudinally along the conveyor 34 is not critical because of the construction of the filling station 9 and in particular the guide structure 42 and the support structure 55. Because the angle B of the data storage device 3 is slightly greater than the angle A of the upper run 38, the storage device will not contact the carrier 5 except at its lower edge portion 51. When the pocket 48 is close enough to the bottom edge 51 and its lowest most point, as signaled by sensor 97, the already positioned storage device 3 is released from vacuum attachment, positive pressure air is provided directing the storage device 3 toward the flange 57 and into the pocket 48 and hence into the respective recess 25 or 26. The sidewalls 27, 28 will guide the respective carrier 5 into position within the respective recess 25, 26 substantially only under the influence of gravity. The through hole 19 is thus aligned with the securement device 31 and will rest in a lower portion of the respective recess and on the securement device 31 until it arrives at the securement station where the collars 74 will press the data storage device over the lock device 32 and onto the securement device 31. After a prescribed number of carriers 5 or a carrier strip 24 passes through the filling station 9A or 9B, the attachment devices 79 attach to another set of data storage devices 3 in the respective magazine 75 will move them into position for insertion into additional respective carriers 5. After passing through the securement station 11, the carriers 24 with their releasably retained data storage devices 3 may be transferred to a take-away conveyor for further downstream processing such as packing, wrapping, or folding in the case of the use of a carrier strip.

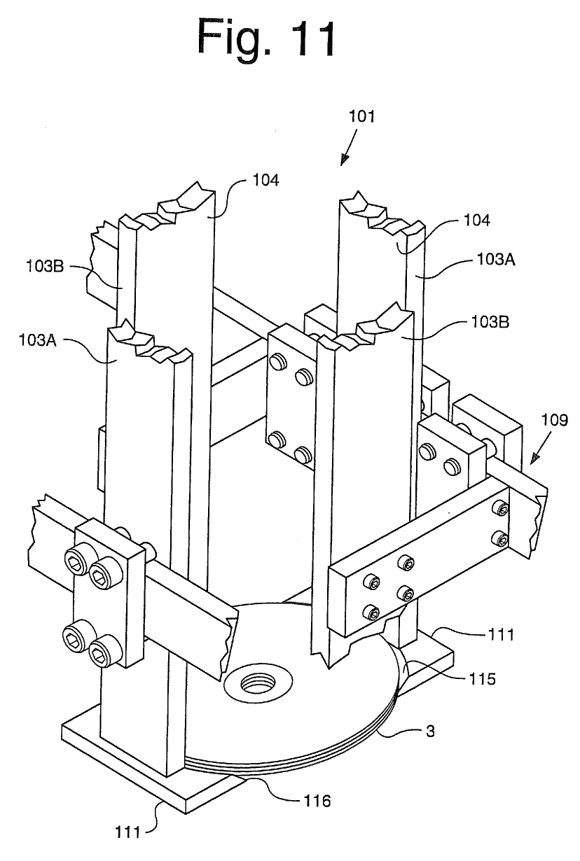

FIGS. 11-13 illustrate a modified form of portions of the apparatus 1 shown in FIGS. 1-8 and as described above. As best seen in FIG. 11, the modified magazine designated generally 101, may be used to replace the magazines 76 as shown in FIGS. 1-8. The magazine 101 includes a plurality of uprights 103, for example, four in quantity and are in spaced apart relationship. The uprights 103 are spaced to receive therebetween data storage devices 3 in a stack that will be generally vertically oriented. The magazine 101 is adapted for feeding the data storage device 3 in a bottom feed manner. The uprights 103 have inside surfaces 104 that in pairs are spaced apart and the spacing is approximately equal to a transverse dimension of the data storage devices 3. The magazine 101 has an open top 106 and a generally open bottom 107. The uprights 103 are suitably secured to a framework support structure designated generally 109, which in turn is suitably mounted to a portion of the apparatus 1.

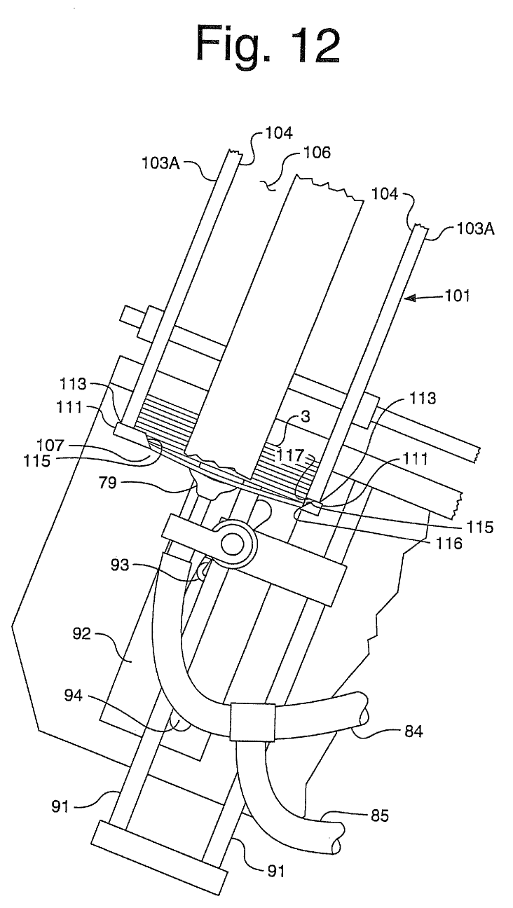

As shown, the uprights 103 are positioned about the data storage devices 103 preferably at 90° intervals, four uprights 103 preferably being used. The uprights are designated in pairs as 103A and 103B with the uprights 103B being positioned on opposite sides of the data storage devices 3 while the uprights 103A are positioned at the front and rear (relative to the conveyor 34) of the data storage devices 3. Retainers 111 are secured to certain of the uprights 103 and preferably the uprights 103A. As shown, the retainers 111 are each suitably secured to a respective bottom end 113. The retainers 111 are in the form of jaws having an inside surface portion 115 and an inside peripheral edge 116. The arc of curvature of each of the retainers 111 is preferably in the range of between about 45° to about 90°. The spacing between the edges 116 through a center point is preferably smaller than the transverse dimension of the data storage device 3 preferably on the order 0.030 to 0.060 of an inch. The surfaces 115 are preferably downwardly and inwardly contoured, for example, being a straight taper, to form a portion of a cone. In a preferred embodiment, and as best seen in FIG. 12, the inside surface 104 of the uprights 103A each project inwardly and over the respective surface 115 forming a ledge 117. Because the surfaces 115 are contoured, a portion of the surfaces 115 form an opening to the edges 116 larger than the transverse dimension of the data storage device 3. Thus, storage devices 3 may move frontwardly and rearwardly slightly to help in removal of the data storage devices 3 from the lower end 107 of the magazine 101. The angle of the surfaces 115 is preferably on the order of between about 30° and about 60° from vertical with a 45° taper having been found useful. As seen in FIG. 12, to remove the lowermost data storage device 3, an attachment device 79 is moved upwardly and releasably secures itself to the lowermost data storage device 3 as described above, through the application of a negative or vacuum pressure through the conduit 84 to the attachment device.

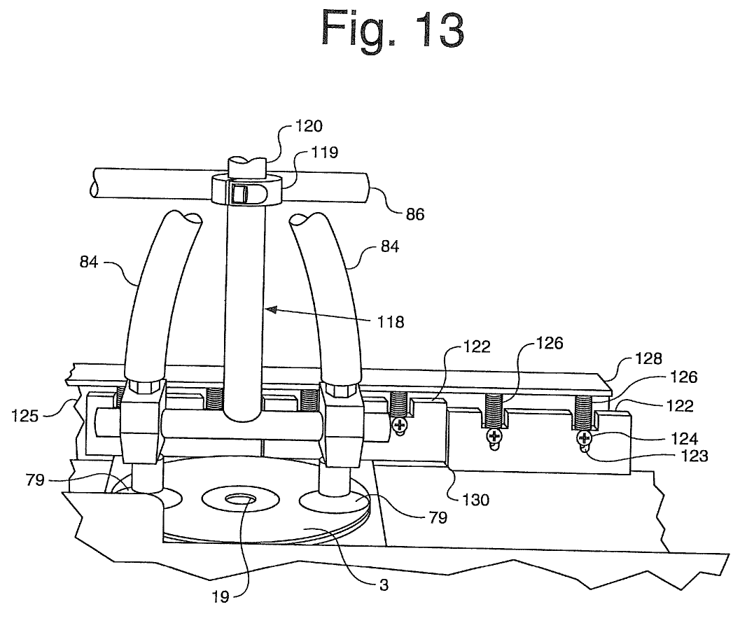

As best seen in FIG. 13, the attachment device used in the modified form of invention includes a plurality of spaced apart attachment devices 79 each connected to a respective conduit 84 and 85. Preferably, each of the attachment devices 79 are positioned for contact with a data storage device 3 each on an opposite side of the through hole 19 preferably along a line though the center of the through hole 19 placing the attachment device 79 about midway between the edges 1 and 16 of each of the retainers 111. However, it is to be noted that the centerline through the attachment devices 79 may be positioned forwardly or rearwardly of the longitudinally (relative to the conveyor 34) extending centerline of the storage device 3 to slightly cant the storage device 3 for disengagement from the retainers 111. The operation of the paired attachment devices 79 is substantially identical to the operation of the single attachment device as described above. By being placed generally along the centerline approximately midway between the edges 116, a data storage device may be flexed downwardly generally about its midpoint which will contract the transverse dimension between the retainers 111 allowing the lowermost data storage device to be pulled downwardly and beyond the edges 116 for subsequent movement for release adjacent carriers 5 moving through the filling station 9 as described above. FIG. 12 shows the attachment devices 79 releasably attached to a lowermost data storage device 3 bending the same downwardly for removal of same from the magazine 101. A portion of a rear retainer 111 is shown broken away to illustrate details of the support of the data storage devices 3 by the retainers 111. The attachment devices 79 are mounted to a generally t-shaped mounting member 118 which is in turn mounted to the member 86. A mounting device 119 such as a split collar mounts the member 118 to the member 86 and allows for position adjustment longitudinally along the shaft portion 120 of the mount 118.

As best seen in FIG. 13, a plurality of resiliently mounted presser guides 122 are mounted, preferably to a support 125. A guide structure 42 need not be used when presser guides 122 are used. The pressers 122 are positioned along the length of the support 125 particularly at each of the filling positions at the filling station 9C. As seen, three resiliently mounted pressers 122 are mounted at one filling position. The pressers 122 are in the form of generally flat plates having a pair of elongate slots 123 through which are received suitable fasteners 124 which movably mount the pressers 122 to the support 125 allowing inward (rearward) and outward (forward) movement under the influence of resilient members 126 such as coil springs mounted over retaining studs (not shown) on the pressers 122 and a rear positioned stop plate 128 which is preferably secured to the support 125. The pressers 122 are biased to an outward or forward position as seen in the right hand pressure 122 in FIG. 13 and when in contact with the carrier 5 move to a rearward position as seen on the two left hand pressers 122 in FIG. 13. The presser 122 urge the carriers 5 into firm engagement with the upper run 38 of the first conveyor 34. It has been found in practice, that three pressers 122 are effective for each storage device loading position at the filling station 9C, described below. The leading edges 130 may be tapered to facilitate rearward movement of the pressers 122 from their forward position to their rearward position. The pressures 122 are particular useful when loading a single DVD or CD into a single carrier 5 when same is not attached to a carrier strip 24.

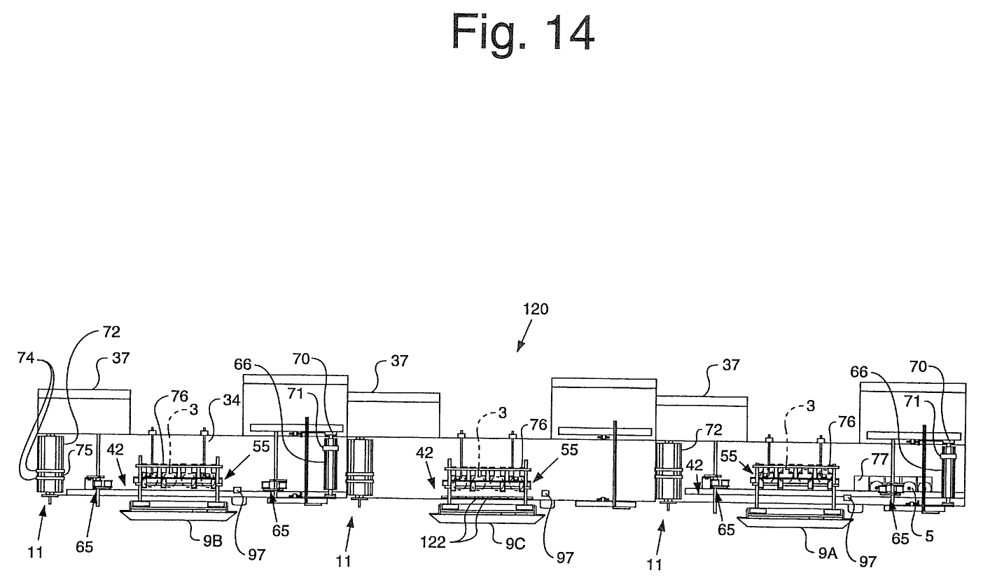

FIG. 14 illustrates another modified form of the invention. It is similar to the form of the invention shown in FIG. 8 and has a plurality of filling stations 9A, 9B, 9C. The filling stations 9A, 9B are described above in reference to the disclosure of the apparatus as shown in FIG. 8. The apparatus 201 includes three filling stations, 9A, 9B, 9C. The filling station 9C is added. By putting a series of filling stations 9 in sequence, a combination of carriers 5 may be loaded with data storage devices 3. For example, at the station 9A of FIG. 14 the top positioned recess 26 of a carrier 5B may be loaded with a data storage device 3. The station 9B, at the left-hand end of the apparatus as shown in FIG. 14, can be used to load a data storage device 3 into the lower recess 25 of the carrier 5B. The filling station 9C can be used to load carrier 5A with a data storage device 3. The station 9C will use the spring-biased plates 122 instead of the guide structure 42. The use of the spring biased plates 122 allows for carriers 5 having different thicknesses to pass thereunder while forming and maintaining the pocket 48. By using a plurality of spring biased plates 122 at each of the loading positions, as seen in FIG. 13, the plates 122 will maintain a formed pocket 48 and guide slot 47 at each loading position at a filling station 9C. While the filling stations are in the loading sequence 9A, 9C, 9B, it is to be understood that the sequence of filling stations could be 9A, 9B, 9C or in 9C, 9A, 9B, providing flexibility in operation of the apparatus 201.

While the foregoing describes certain preferred embodiments of the present invention, it is to be understood modifications may be made to the invention and still provide an apparatus for installing data storage devices into carriers. It will also be apparent to those skilled in the art that many other modifications to this invention are possible without departing from the inventive concepts herein. It is therefore, to be understood that, within the scope of the appended claims, this invention may be practiced otherwise and as specifically described, and the invention is not to be restricted except in the spirit of the appended claims.

1. An apparatus for inserting a data storage device into a carrier, said apparatus including:
a conveyor system having a first conveyor with a feed end portion and a discharge end portion and adapted to convey a data storage device carrier in a direction from the feed end portion to the discharge end portion;
a first filling station having a device for placing a data storage device adjacent to a said carrier associated with the conveyor; and
a guide structure positioned adjacent the conveyor forming a groove for receipt of a portion of a said carrier therein and forming an opening into a lower portion of a recess in a carrier said opening being adapted to allow a portion of a said data storage device to move into a said recess through said opening.

2. An apparatus as set forth in claim 1 wherein the apparatus being operable to position a said carrier at a first angle of at least about 25° from horizontal at the filling station.

3. An apparatus as set forth in claim 1 wherein the apparatus being operable to position a said carrier at a first angle of at least about 35° from horizontal at the filling station.

4. An apparatus as set forth in claim 1 wherein the apparatus being operable to position a said carrier at a first angle in the range of between about 35° and about 60° from horizontal at the filling station.

5. An apparatus as set forth in claims 2, 3, and 4, including a support at the first filling station operable to position a said data storage device at a second angle greater than the first angle by at least about 2° and wherein a lower portion of a said data storage device being closer to its respective carrier than a top portion of a respective said data storage device.

6. An apparatus as set forth in claim 1 wherein the first conveyor including a first conveyor belt adapted to move carriers in a direction from the feed end portion toward the discharge end portion, said first conveyor belt having an exposed first surface portion for engaging said carriers and wherein the conveyor system including a second conveyor belt having a second surface portion facing and spaced from a portion of the first surface portion forming a portion of the guide structure and the groove.

7. An apparatus as set forth in claim 6 wherein the apparatus including a power drive associated with the first and second conveyor belts and operable to effect movement of the first and second conveyor belts at the filling station at substantially the same speeds.

8. An apparatus as set forth in claim 7 including a securement station operable to effect engagement between a said data storage device and respective said carrier.

9. An apparatus as set forth in claim 8 wherein the securement station including a grooved roller arrangement rotatably mounted to the apparatus.

10. An apparatus as set forth in claim 2 including a second filling station spaced from the first filling station and adapted to load a data storage device into a second recess of a carrier.

11. An apparatus as set forth in claim 5 wherein the filling station including an attachment device mounted on a drive and being operable to releasably attach to a said data storage device and remove a said data storage device from a storage magazine and move a removed said data storage device to a release and load position adjacent said groove.

12. An apparatus as set forth in claim 11 wherein the attachment device including a pair of spaced apart suction cups connected in flow communication with a vacuum source.

13. An apparatus as set forth in claim 12 wherein the suction cups are also connected in flow communication with a source of positive pressure fluid wherein the apparatus is operable to apply vacuum to the suction caps and a said data storage device to effect removal of a said data storage device from a storage magazine and to release the vacuum and apply positive pressure air to effect release of an attached said data storage device.

14. An apparatus as set forth in claims 2 or 13 wherein the apparatus including at least one bottom feed storage magazine adapted for storing a plurality of data storage devices in stacked relationship, the storage magazine including a pair of generally opposed jaws each having a downwardly and inwardly contoured surface with a lower and inward edge portion, the edge portions being spaced from one another through a center point in distance less than a diameter of a portion of a said data storage device to be stored in the storage magazine.

15. An apparatus as set forth in claim 6 wherein the guide structure including a second conveyor belt spaced from and generally parallel to the first conveyor belt to be positioned on one side of a said carrier and the first conveyor belt being positioned on an opposite side of a said carrier.

16. A method of loading a plurality of data storage devices each into a respective recess of a respective carrier, said method including:
orienting a carrier at an angle of at least about 25° from horizontal, said carrier having at least one storage recess with a portion exposed to receive a respective data storage device therein;
forming a pocket adjacent a lower positioned portion of a said recess;
gripping a data storage device in storage;
removing a data storage device from storage;
positioning a removed data storage device adjacent a respective said pocket; and
releasing the grip on the data storage device and allowing said data storage device to move generally downwardly into a respective said pocket and respective said recess.

17. A method as set forth in claim 16 including guiding movement of the data storage device into a respective recess using a sidewall partially defining a respective recess.

18. A method as set forth in claim 17 including releasably securing a said data storage device in a respective said recess.

19. A method as set forth in claim 17 including positioning a said data storage device at an angle from horizontal greater than the angle of a respective said carrier prior to release from an attachment device releasably retaining the attachment device.

20. A method as set forth in claim 19 wherein the carrier is oriented at an angle of at least about 35° from horizontal.

21. A method as set forth in claim 19 wherein the carrier is oriented at an angle in the range of between about 35° and about 60° from horizontal.

22. A method as set forth in claim 19 wherein said gripping is with a vacuum suction cup.

23. A method as set forth in claim 22 applying a positive pressure fluid after vacuum is released to effect said releasing.

24. A method as set forth in claim 18 said releasably securing is effected by moving a through hole past a lock device by applying force to the data storage device on each of opposite sides of the through hole.
